(19) United States
(12) Patent Application Publication
(10) Pub. No.: US 2017/0131801 A1
(43) Pub. Date: May 11, 2017

(54) METHOD FOR DISPLAYING HANDWRITING IN A PDF FILE

(71) Applicant: Fujian Foxit Software Development Joint Stock Co., Ltd., Fuzhou (CN)

(72) Inventors: Yuqian Xiong, Beijing (CN); Sunliang Liu, Beijing (CN)

(73) Assignee: Fujian Foxit Software Development Joint Stock Co., Ltd., Fuzhou (CN)

(21) Appl. No.: 15/317,985

(22) PCT Filed: Jun. 19, 2014
(86) PCT No.: PCT/CN2014/000605

§ 371 Date: Dec. 12, 2016

(51) Int. Cl. G06F 3/0354; G06T 11/40; G06F 3/0488; G06T 11/20

(52) U.S. Cl. CPC G06F 3/03545; G06T 11/203; G06T 11/40; G06F 3/04883

(57) ABSTRACT

A method for displaying handwriting in a PDF file includes: determining the embedding location of handwriting annotated in a PDF file; correspondingly recording coordinates and pressure data of each stroke point, on the screen, contacted by a stylus, and recording the sequence in which the stylus makes contact with the stroke points; establishing a correlation between pressure data and color, thus establishing a correlation between coordinates of the stroke points and color; displaying the stroke points in their colors, and connecting all of the stroke points according to the sequence in which the stylus makes contact with the stroke points, forming handwriting data, wherein color of the connecting line between consecutive stroke points is displayed according to a function; forming a graphic according to the handwriting data, and combining the handwriting data with the graphic to form an annotation; and embedding the handwriting annotation in the embedding.

### TECHNICAL FIELD

The present invention relates to the technical field of displaying handwriting in a PDF file, in particular to a method for displaying the handwriting in a PDF file.

### BACKGROUND

Along with the development of sensors, touch screens, and other technologies, it is possible to display handwriting input by a stylus in a PDF file. In prior art, by storing the coordinates of each stroke point and a sequence in which the stylus makes contact with the stroke point, respective stroke points are connected to form handwriting data, then the handwriting data are embedded into the PDF file, and finally, the input handwriting is displayed in the PDF file. The technology has a defect that the handwriting data are merely connecting lines of the stroke points and are single in color, which are greatly different from the actual handwriting of a user, therefore, a human-computer interactive interface in the prior art is poorer, and the application of this technology to the fields of drawing, signature, etc., are severely affected.

### BRIEF DESCRIPTION

The technical problem to be solved by the present invention is to provide a method for displaying handwriting in a PDF file, which can enable the displayed handwriting to more closely approach to the actual handwriting of a user, increase the friendliness of a human-computer interactive interface and broaden the fields of application.

The technical solution of the present invention to solve the technical problem is as follows: a method for displaying handwriting in a PDF file, wherein the handwriting is written on a screen by a stylus; and the method comprises:

Step 1: opening the PDF file, and determining an embedding location of a handwriting annotation into the PDF file;

Step 2: correspondingly recording the coordinates of each stroke point, on the screen, contacted by the stylus, and the stylus pressure data for such stroke point and recording a sequence in which the stylus makes contact with the stroke points;

Step 3: establishing a correlation relationship between the stylus pressure data and a color for each stroke point, thus establishing a correlation relationship between the coordinates and the color of the stroke points;

Step 4: displaying each stroke point in its color corresponding to the coordinates, connecting all of the stroke points according to the sequence in which the stylus makes contact with the stroke points, and forming handwriting data, wherein a color of a connecting line between consecutive stroke points is displayed according to a preset first function rule;

Step 5: forming an appearance graphic according to the handwriting data, and combining the handwriting data with the appearance graphic to form the handwriting annotation;

Step 6: embedding the handwriting annotation into the embedding location in the PDF file.

The present invention has the beneficial effects that the present invention records the coordinates and pressure data of each stroke point, and establishes a correlation relationship between the coordinates and the pressure data of the stroke points and the color, in this way, each stroke point is displayed on the screen by the color corresponding to the coordinates of the stroke point, a color of a connecting line between consecutive stroke points is displayed according to the preset first function rule, therefore, in the present invention, the stylus pressure for each stroke point is embodied by the color, hence, the handwriting displayed by embedding the handwriting annotation into the PDF file more closely approaches to the actual handwriting of the user, which improves the friendliness of a human-computer interactive interface, and the method can be conveniently applied to the fields such as drawing, etc., thereby broadening the application fields of the present invention.

Based on the above technical solution, the present invention can be improved as follows:

Further, step 3 further comprises: establishing a correlation relationship between the stylus pressure data and a width for each stroke point, thus establishing a correlation relationship between the coordinates of the stroke points and the width; and

then in the handwriting data formed in step 4, the width of the connecting line between consecutive stroke points is displayed according to a preset second function rule.

Further, in step 2, the method of recording the stylus pressure data for such stroke point comprises: converting, by a sensor, the sensed stylus pressure for such stroke point, into pressure data, and transmitting the pressure data to a controller, and storing the pressure data into a memory by the controller.

### BRIEF DESCRIPTION OF THE DRAWINGS

FIG. 1 is a flow chart of a method for displaying handwriting in a PDF file provided by the present invention.

### DETAILED DESCRIPTION

The principle and features of the present invention are described in combination with the drawings, and the embodiments are merely intended to explain the present invention rather than limiting the scope of the present invention.

The present invention provides a method for displaying handwriting in a PDF file, the handwriting in the present invention is written on a screen by a stylus, the handwriting can be Chinese characters, or pictures, letters, etc. The screen in the present invention can be a touch screen, a screen of a writing pad, a display, or the like. According to different screens, the stylus is also different, for example, when the screen is the touch screen or the screen of the writing pad, the stylus can be a finger of a person, or any hard article, such as a pencil and a pen; and when the screen is a display, the stylus can be implemented as a mouse.

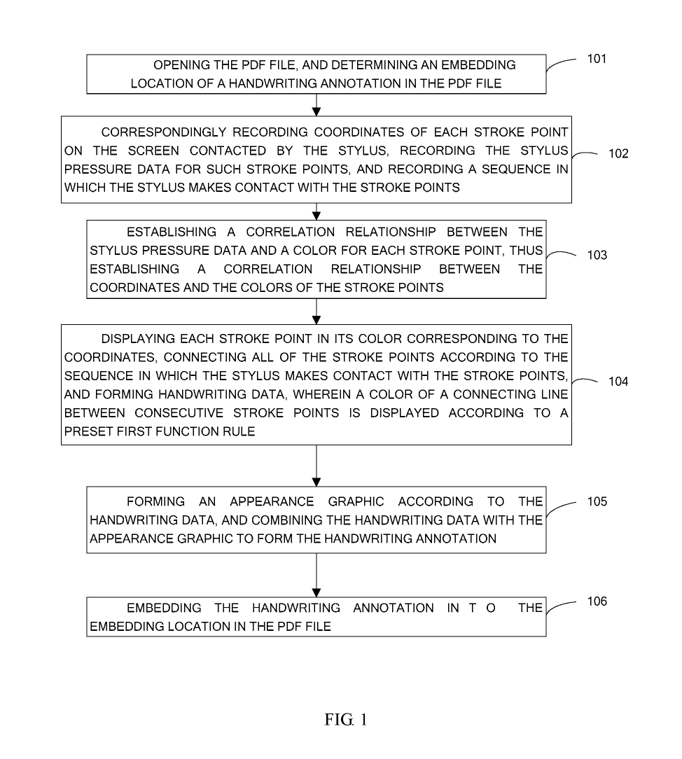

FIG. 1 is a flow chart of a method for displaying handwriting in a PDF file provided by the present invention, and as shown in FIG. 1, the method comprises:

Step 101: opening the PDF file, and determining an embedding location of a handwriting annotation into the PDF file.

PDF is short for Portable Document Format, and is a format of an electronic file, and the PDF file is the electronic file applying the PDF format.

According to the present invention, the handwriting written on the screen by the stylus is reflected by a form of handwriting annotation, the handwriting annotation is embedded into the PDF file, such that the handwriting written by the stylus is displayed in the PDF file. This step is intended to determine the embedding location of the handwriting annotation into the PDF file, usually, a blank location in the PDF file is selected as the embedding location of the handwriting annotation, of course, the location with words, tables, or pictures can also be used as the embedding location as required.

Step 102: correspondingly recording the coordinates of each stroke point, on the screen, contacted by the stylus, and the stylus pressure data for such stroke point and recording a sequence in which the stylus makes contact with the stroke points.

In this step, the recorded content comprises: the coordinates of each stroke point, on the screen, contacted by the stylus, the stylus pressure data for such stroke point and the sequence in which the stylus makes contact with the stroke points. The stylus pressure data for such stroke point refers to a pressure value applied to the stroke point by the stylus, and in this step, the coordinates of each stroke point, on the screen, contacted by the stylus and the stylus pressure data for such stroke point are correspondingly recorded and stored.

In this step, the method of recording the stylus pressure data for such stroke point comprises: converting, by a sensor, the sensed stylus pressure for such stroke point, into pressure data, and transmitting the pressure data to a controller, and storing the pressure data into a memory by the controller. The method is executed in a situation in which the screen adopts the touch screen, the screen of the writing pad, etc. When the screen adopts the display and the stylus is implemented by adopting the mouse, the stylus pressure data for the stroke point can be recorded in a simulation manner, i.e., in this step, the method of recording stylus pressure for such stroke point comprises: recording a moving speed of the mouse at the position of the stroke point, converting the moving speed into pressure data, and transmitting the pressure data to a controller, and further storing the pressure data into a memory by the controller.

Step 103: establishing a correlation relationship between the stylus pressure data and a color for each stroke point, thus establishing a correlation relationship between the coordinates and the color of the stroke points.

Based on step 2, in which the correlation relationship between the coordinates of each stroke point, on the screen, contacted by the stylus, and the stylus pressure data for such stroke point is established, further, a correlation is established between the stylus pressure data and a color for each stroke point, thus, the correlation is established between the coordinates of each stroke point, on the screen, contacted by the stylus and the color by taking the stylus pressure data for the stroke point as a medium, and this correlation relationship means a determination of the color of each stroke point, on the screen, contacted by the stylus and displayed on the screen.

Step 104: displaying each stroke point in its color corresponding to the coordinates, connecting all of the stroke points according to the sequence in which the stylus makes contact with the stroke points, and forming handwriting data, wherein a color of a connecting line between consecutive stroke points is displayed according to a preset first function rule.

Here, the first function rule can be a cosine rule, a sine rule, a linear rule, a random change rule, a normal distribution rule, and any other preset function rule. And a rule falls within the protection of the present invention as long as it belongs to the function rule. By taking the linear rule as an example, a color of a connecting line between the consecutive stroke points is displayed according to the linear rule, it means that the change of the color from the first stroke point to the color of the final stroke point on the connecting line is linear. The case can be that the color of the first stroke point is the densest, and the color of the last stroke point is the thinnest, and vice versa. Other function rules are deduced by analogy.

Based on the established correlation relationship between the coordinates and the color of the stroke points in step 3, in this step, each stroke point can be displayed by the color corresponding to its coordinates.

On the basis that step 2 records the sequence in which the stylus makes contact with the stroke points, in this step, all strokes are connected to form handwriting data, the content of which can be pictures, and can also be any content such as Chinese characters, letters, numbers, etc.

Step 105: forming an appearance graphic according to the handwriting data, and combining the handwriting data with the appearance graphic to form the handwriting annotation.

The handwriting annotation used in the present invention is essentially an annotation into the PDF file. Therefore, Except the handwriting annotation has handwriting data reflecting the handwriting content, the handwriting annotation should also have an appearance graphic, and a shape, a size, a background color, etc., of the appearance graphic can be preset, and can be in a form of a picture, or a simple graphic.

The method of combining the handwriting data with the appearance graphic belongs to the prior art and is not repeated.

The handwriting annotation formed by combining the handwriting data with the appearance graphic can be fixed, which means that the content of the handwriting annotation (i.e., the handwriting data therein) is non-editable, of course, the handwriting annotation can also be editable to adapt to the demands of modification and updating.

Step 6: embedding the handwriting annotation into the embedding location in the PDF file.

The handwriting annotation is an annotation of the PDF file in essence, and thus can be embedded into any embedding location in the PDF file, and the embedding location has been determined in step 101. The method of embedding the handwriting annotation into the PDF file belongs to the prior art, and is not repeated in the present invention.

The handwriting annotation can be displayed in the embedding location of the PDF file always, and the handwriting annotation can be seen in the embedding location as long as the PDF file is opened. The handwriting annotation can also be in a hidden form, that is, the handwriting annotation is not displayed till its embedding location is clicked or touched. Otherwise, the handwriting annotation is in a hidden invisible form, which is favorable to set it in a non-blank location with words, pictures, tables, or the like.

Thus it can be seen that the present invention records the coordinates and pressure data of each stroke point, and establishes a correlation relationship between the coordinates and the pressure data of the stroke points and the color, in this way, each stroke point is displayed on the screen by the color corresponding to the coordinates of the stroke point, a color of a connecting line between consecutive stroke points is displayed according to the preset function rule, therefore, in the present invention, the stylus pressure for each stroke point is embodied by the color, hence, the handwriting displayed by embedding the handwriting annotation into the PDF file more closely approaches to an actual handwriting of the user, which improves the friendliness of a human-computer interactive interface, the method can be conveniently applied to the fields such as drawing, signature, etc,. thereby broadening the application fields of the present invention.

The above method reflects the stylus pressure for each stroke point with the color, in fact, the pressure can also be reflected in other forms, for example, the width of the connecting line. Thus, the step 103 also comprises: establishing a correlation relationship between the stylus pressure data and a width for each stroke point, thus establishing a correlation relationship between the coordinates of the stroke points and the width; and then in the handwriting data formed in step 104, the width of the connecting line between the consecutive stroke points is displayed according to a preset second function rule, the second function rule here can be different from the first function rule for displaying a color of a connecting line between the consecutive stroke points. And of course, the first function rule and the second function rule can also be the same. The second function rule can be a cosine rule, a sine rule, a linear rule, a random change rule, a normal distribution rule, and any other preset function rule. And a rule falls within the protection of the present invention as long as it belongs to the function rule. If the linear rule as the second function rule is an example, the width of the connecting line between the consecutive stroke points is gradually changed, from a width corresponding to the coordinates of one stroke point initially contacted by the stylus, to a width corresponding coordinates of another stroke point later contacted by the stylus. Other types of the second function rule are deduced by analogy.

Thus it can be seen that the present invention has the following advantages:

(1) the present invention records the coordinates and pressure data of each stroke point, and establishes a correlation relationship between the coordinates, the pressure data, the color and the width of the stroke points in this way, each stroke point is displayed on the screen by the color corresponding to the coordinates of the stroke point, the color of the connecting line between consecutive stroke points is displayed according to the preset function rule, the size of the pressure data can also be reflected by width, therefore, in the present invention, the stylus pressure for each stroke point is embodied by the color and the width, hence, the handwriting displayed by embedding the handwriting annotation into the PDF file more closely approaches to the actual handwriting of the user, which improves the friendliness of a human-computer interactive interface, the method can be conveniently applied to the fields such as drawing, etc., thereby broadening the application fields of the present invention.

The above mentioned is preferable embodiments of the present invention merely rather than limiting the present invention, and any modifications, equivalent substitutions, improvements, etc., made in the spirit and principle of the present invention all fall within the protection scope of the present invention.

1. A method for displaying handwriting in a PDF file, wherein the handwriting is written on a screen by a stylus, the method comprising the following steps:
Step 1: opening the PDF file, and determining an embedding location of a handwriting annotation into the PDF file;
Step 2: correspondingly recording coordinates of each stroke point on the screen contacted by the stylus, recording the stylus pressure data for such stroke points, and recording a sequence in which the stylus makes contact with the stroke points;
Step 3: establishing a correlation relationship between the stylus pressure data and a color for each stroke point, thus establishing a correlation relationship between the coordinates and the color of the stroke points;
Step 4: displaying each stroke point in its color corresponding to the coordinates, connecting all of the stroke points according to the sequence in which the stylus makes contact with the stroke points, and forming handwriting data, wherein a color of a connecting line between consecutive stroke points is displayed according to a preset first function rule;
Step 5: forming an appearance graphic according to the handwriting data, and combining the handwriting data with the appearance graphic to form the handwriting annotation; and
Step 6: embedding the handwriting annotation into the embedding location in the PDF file.

2. The method according to claim 1, step 3 also comprises: establishing a correlation relationship between the stylus pressure data and a width for each stroke point, thus establishing a correlation relationship between the coordinates of the stroke points and the width; and
then in the handwriting data formed in the step 4, the width of the connecting line between consecutive stroke points is displayed according to a preset second function rule.

3. The method according to claim 1, wherein, in step 2, the method of recording the stylus pressure data for such stroke point comprises: converting, by a sensor, the sensed stylus pressure for such stroke point, into pressure data, and transmitting the pressure data to a controller, and storing the pressure data into a memory by the controller.

4. The method according to claim 2, wherein, in step 2, the method of recording the stylus pressure data for such stroke point comprises: converting, by a sensor, the sensed stylus pressure for such stroke point, into pressure data, and transmitting the pressure data to a controller, and storing the pressure data into a memory by the controller.
